(19) United States
(12) Patent Application Publication
(10) Pub. No.: US 2026/0317930 A1
(43) Pub. Date: Oct. 15, 2026

(54) DEGASSING DEVICE FOR AN ELECTROLYSIS PLANT, AND ELECTROLYSIS PLANT

(71) Applicant: JOHN COCKERILL HYDROGEN BELGIUM, Seraing (BE)

(72) Inventor: Nicolas Maricau, Seraing (BE)

(73) Assignee: JOHN COCKERILL HYDROGEN BELGIUM, Seraing (BE)

(21) Appl. No.: 19/484,083

(22) PCT Filed: May 31, 2024
(86) PCT No.: PCT/EP2024/065048

§ 371 Date: Nov. 13, 2025

(30) Foreign Application Priority Data
May 31, 2023 (BE) BE2023/5436

(51) Int. Cl. C25B 15/08; B01D 19/00; C25B 1/04

(52) U.S. Cl. CPC C25B 15/08; B01D 19/0042; C25B 1/04

(57) ABSTRACT

An electrolysis plant for producing dihydrogen (H₂) and dioxygen (O₂) by electrolysis of water is provided. The plant includes a degassing device (1) which includes an opening for a first gas-liquid mixture supply pipe (11), an opening for a liquid discharge pipe (12) arranged below the level of the gas-liquid interface (15) of the chamber (14), and an opening for a gas discharge pipe (13) arranged above the level of the gas-liquid interface (15) of the degassing chamber (14). Furthermore, the device has one or more additional openings for one or more additional gas-liquid mixture supply pipes (21, 22), said one or more additional gas-liquid mixture supply pipes (21, 22) being arranged such that the jets of gas-liquid mixture introduced into the degassing chamber (14) via the supply pipes (11, 21, 22) intersect within the gas-lye mixture in the degassing chamber (14).

The present invention pertains to the technical field of electrolysis and more particularly to an electrolysis plant for the production of dihydrogen (H₂) and dioxygen (O₂) by electrolysis of water. According to a first of its aspects, the invention relates to a degassing device which can be used in a plant for the production of dihydrogen and dioxygen by electrolysis of water. Another aspect of the invention relates to a plant for the production of dihydrogen and dioxygen by electrolysis of water, containing such a degassing device. Yet another aspect of the invention relates to a degassing method.

### INDICATION OF THE PRIOR ART

The need to reduce greenhouse gas production and to utilize renewable energies is now well known. Dihydrogen is an alternative to hydrocarbons because it is a readily storable energy carrier, unlike electricity, and its oxidation releases a very large energy (285 kJ/mol).

There are several known ways of producing gaseous dihydrogen; the most advantageous is to electrolyze the water molecule, as this is a high-yield reaction that does not directly produce CO₂, unlike the heavily used processes of methane, coal and hydrocarbon reforming.

There are three main types of electrolyzers known for water electrolysis:
alkaline electrolyzers (AWE), which are characterized by the use of a liquid electrolyte that allows the transfer of hydroxyl ions (OH⁻) from the cathode to the anode;
high-temperature electrolyzers, whose electrolyte is a ceramic; and
membrane electrolyzers (PEM), whose electrolyte is a proton-conducting ion exchange membrane.

In all three cases, the system must be supplied with water of very high purity (supplying, in the case of alkaline electrolyzers, an electrolyte solution of sodium hydroxide (NaOH) or potassium hydroxide (KOH)). Although the remainder of the description, for reasons of brevity, will refer to an alkaline electrolyzer, it is appreciated that the present invention also applies to the membrane electrolyzer (for example, a proton exchange membrane).

According to the well-known process of the prior art, an electrolyte solution (known as the lye) is brought within a set of electrolytic cells (known as the electrolyzer stack) through a specific inlet. The electrolyte solution passes through the electrolyzer stack. Water is broken down into gaseous molecules of dihydrogen, H₂, at the cathode, and dioxygen, O₂, at the anode. A diaphragm usually separates the anode from the cathode so that, under normal conditions, the dihydrogen and dioxygen do not mix. The plant comprises an outlet for dihydrogen and electrolyte circulating on the cathode side (catholyte) and an outlet for dioxygen and electrolyte on the anode side (anolyte). In other words, there are two separate streams, and so there is a gas-liquid separator dedicated to the separation of dihydrogen from the catholyte, and a gas-liquid separator for the separation of dioxygen from the anolyte. The liquid outlets of the two gas-liquid separators are then mixed before feeding the electrolyzer stack again. In both streams, at the outlet of the electrolyzer stack, the liquid phase (lye) is charged with gas bubbles. At the outlet of the gas-liquid separator, only a few gas bubbles remain in the lye evacuated through the lower orifice of the gas-liquid separator dedicated to the liquid phase, while the majority gas phase is extracted from the gas-liquid separator through the upper orifice of the gas-liquid separator. For various reasons, it is important to separate the gas from the lye. First of all, the more the gas is separated from the electrolyte, the greater the production of gas, which contributes to the good electrochemical yield of the process. Next, the H₂/O₂ mixture is highly explosive. If separation does not take place correctly, a significant amount of gas, commonly referred to as “residual gas”, is entrained at the liquid outlet of the gas-liquid separator. During the next circulation in the electrolyzer stack (the electrolyte rotates in a closed loop), some of this gas passes into the other compartment and therefore to the wrong side.

These gas-liquid separators, well known in the art, comprise a degassing chamber having an opening for a gas-liquid mixture supply pipe, an opening for a liquid discharge pipe arranged below the level of the gas-liquid interface of the degassing chamber, and an opening for a gas discharge pipe arranged above the level of the gas-liquid interface of the degassing chamber. Each of the outlets of the electrolyzer stack for the dihydrogen-lye and dioxygen-lye mixtures respectively is connected to such a gas-liquid separator. FIGS. 1 and 2 schematically depict known gas-liquid separators aligned respectively along a horizontal or vertical main axis A. Document FR-A1-2949479, for example, describes such gas-liquid separators. Another gas separator is known from document EP-A1-4001464. In this facility, the products of electrolysis are highly corrosive (alkaline) and brought to high temperatures. The degassing plant must therefore be able to withstand these extreme conditions, which requires the use of very expensive materials such as nickel alloys. This document proposes a solution whereby the gas-liquid mixture to be degassed is introduced in several fractions. The hotter fractions are introduced directly into the part of the degassing chamber above the gas-liquid interface while colder fractions are introduced into a channel circumscribing the degassing chamber. The gas-liquid mixture from the channel can pass into the degassing chamber via a separation element. The assembly thus makes it possible to cool the mixture in the degassing chamber.

The principle of extraction of gas bubbles from the liquid phase is based on the Archimedes principle. The efficiency of the separation depends primarily on gravity and on the difference in density between the liquid and gas phases, but also on the viscosity (friction of the gas bubbles in the liquid part). The gas-liquid mixture must therefore reside long enough in the degassing chamber to allow all of the gas bubbles to be extracted from the lye. In the remainder of the description, gas-liquid separators of this kind will be designated by the term gravity gas-liquid separators. These gravity gas-liquid separators are characterized by substantial dimensions. In some gas-liquid separators, equipment can be inserted to speed up separation (for example, a honeycomb structure) or to homogenize the flow and have a uniform residence time for all streamlines. Gas bubbles still present in the liquid phase can be quantitatively significant; in other words, not all the gas bubbles manage to be extracted from the liquid phase so as to be evacuated by an ad hoc discharge pipe on the upper or side wall of the degassing chamber. This poses a number of problems. As already indicated above, the output of the electrolyzer stack suffers from this loss of gas. In addition, in conventional electrolysis plants, the two lye fractions discharged from the gas-liquid separator are combined and mixed in an intermediate tank before being fed back into the electrolyzer stack in a closed loop. Owing to incomplete separation, a potentially significant amount of residual dihydrogen and residual dioxygen may be fed back into the electrolyzer stack, so that the residual dioxygen is on the cathode side while the dihydrogen is directed to the anode. As already indicated, it is well known that the dihydrogen/dioxygen gas mixture is explosive even at a fairly low concentration and this situation is dangerous for personnel and the plant. The gases thus produced also have a very mediocre purity, which requires an additional purification step.

One solution to this problem is to increase the size of the gas-liquid separators, which in turn gives rise to new problems, related to the additional cost, the complexity of manufacturing and transporting these gas-liquid separators, and the increase in the size of the production works.

It would therefore be desirable to be able to provide a degassing device that allows virtually complete degassing of the discharges (dihydrogen/lye and dioxygen/lye of the electrolytic cells). Ideally, a degassing device of this kind should be able to furnish the expected result when the system is operated at full load (high discharge flow rate) or at reduced load (low discharge flow rate).

Indeed, it should also be taken into account that gas-liquid separators in electrolyzers do not always produce dihydrogen and dioxygen at their nominal load (unlike similar systems for other industries or applications) and that the system must be efficient regardless of the amount of gas to be separated. This is because, when the volume of gas decreases, the purity of the gases goes down since proportionally the coalescence of the gas bubbles, which are larger and easier to extract, is not the same.

### DISCLOSURE OF THE INVENTION

According to the invention, this problem has been solved with a degassing device as defined in claim 1. According to the prior art, the lye-dihydrogen mixtures from several electrolyzer stacks are combined in a single pipe before being sent in a single jet into the degassing device. Likewise, the lye-dioxygen mixtures from several stacks are combined in a single pipe before being sent in a single jet into the degassing device. The inventor believed that it was possible not to combine these jets, to take advantage of their number and to inject them separately into the degassing device. In the case of a single electrolyzer stack, the inventor believed that it was possible to split the jet of lye-dihydrogen or lye-dioxygen mixture into two or more jets before injecting them into the respective degassing devices. The supply pipes for supplying gas-liquid mixture to the degassing chamber should then be arranged in such a way that the jets of gas-liquid mixture introduced into the degassing chamber by these supply pipes interact with one another. “Interact with one another” means that the jets of gas-liquid mixture intersect within the gas-lye mixture in the degassing chamber, the gas bubbles contained in the gas-lye mixture then being more likely to collide, more rapidly and more regularly, than with a device according to the prior art in such a way as to promote the creation of larger gas bubbles within the gas-lye mixture itself. In other words, the coalescence of the gas bubbles is enhanced following the intersection of the jets in the gas-lye mixture contained in the gas-liquid separation device. As a result, the contents of the gas-lye mixture in the gas-liquid separator contain gas bubbles which are more easily extracted from the gas-lye mixture after they have increased in size. The extraction mechanism follows the same scheme as described in the prior art, namely that i) the gas bubbles rise to the gas-liquid interface owing to gravity and the liquid-gas density ratio, enter the gaseous volume above the interface, and end their travel by escaping through the gas discharge pipe of the degassing chamber; and ii) the liquid phase flows through the liquid discharge pipe located in the lower part of the separation device. For identical dimensions of the gas-liquid separator, this liquid phase contains significantly fewer gas bubbles compared to those that can be extracted from a traditional gas-liquid separator with a single feed.

The configuration providing the best interaction between the jets entering the degassing chamber is to arrange the supply pipes such that the jets intersect at an angle α of between 15 and 180°. Below 15°, the jets are almost parallel and interact less effectively. Interaction is optimal starting from an angle α of 90°. At 180°, the jets meet head-on and interaction is at a maximum.

Within the meaning of the invention, gas-liquid jets may thus be injected into the degassing chamber of the device in two or more jets. There may be as many jets as desired. However, it must be borne in mind that by splitting a jet into several jets, the quantity of lye-gas mixture and the energy of the incoming jets are split accordingly. This number should thus be reasonable. For example, it is considered reasonable not to split the incoming jet into more than three jets. However, this constraint can be overcome by supplying energy to the jets entering the degassing chamber, for example by propelling or accelerating them using a pump or an injector, or by reducing the inlet section, namely by reducing the section of the supply pipes.

The degassing chamber of the gas-liquid separator may have a horizontal or vertical main axis.

Ideally, the liquid-gas mixture supply opening of the degassing chamber is located opposite, along the main axis of said degassing chamber, at least one of the outlet openings of the degassing chamber. Thus, the liquid or the gas respectively follows longer paths in the degassing chamber before being discharged, and the separation is more efficient.

Apart from this, it should also be noted that the precise location of the discharge openings of the degassing chamber is not critical, meaning that the design of the degassing device may have some flexibility in the choice of the location of these openings. Of course, the discharge opening for the degassed liquid phase must be located below the gas-liquid interface of the degassing chamber, for example through the bottom wall or one of the side walls of the degassing chamber. Similarly, the discharge opening for the gas phase must be located above the gas-liquid interface of the degassing chamber, for example through the upper wall or one of the side walls of the degassing chamber.

According to another of its aspects, the invention pertains to a water electrolysis plant comprising a degassing device as defined above. The electrolysis plant may include an alkaline electrolyzer, a membrane electrolyzer or a high-temperature electrolyzer. Preferably, an alkaline electrolyzer is used. It is possible to provide a sensor making it possible to detect the quantity of residual gas leaving the degassing chamber. The information measured by the sensor is supplied to a control module of a valve making it possible, depending on the level of gas detected in the liquid, to inject the liquid discharged from the degassing chamber back into the degassing chamber in order to refine the separation or to supply an intermediate tank with the liquid discharged from the degassing chamber, where it is mixed with the liquid phase from the other gas-liquid separator.

According to yet another of its aspects, the invention also pertains to a degassing method for degassing a gas-liquid mixture in an electrolysis plant as described above. According to this method of the invention,
a part of the gas-liquid mixture is introduced through the first supply pipe into the degassing device,
one or more other parts of the gas-liquid mixture is (are) introduced through one or more additional supply pipe(s) into the degassing chamber.

According to the invention, the jets of gas-liquid mixture introduced into the degassing chamber through the supply pipes intersect within the gas-lye mixture in the degassing chamber. Advantageously, at least one of the jets injected into the degassing chamber is accelerated, propelled or ejected into the degassing chamber.

### BRIEF DESCRIPTION OF THE FIGURES

The invention will now be described by means of the figures, which have no purpose other than that of illustrating the present invention. In these figures, schematically,

FIG. 1 depicts a degassing device according to the prior art arranged horizontally

FIG. 2 depicts a degassing device according to the prior art arranged vertically

FIG. 3 depicts a degassing device according to the invention arranged horizontally

FIG. 4 depicts a degassing device according to the invention arranged vertically

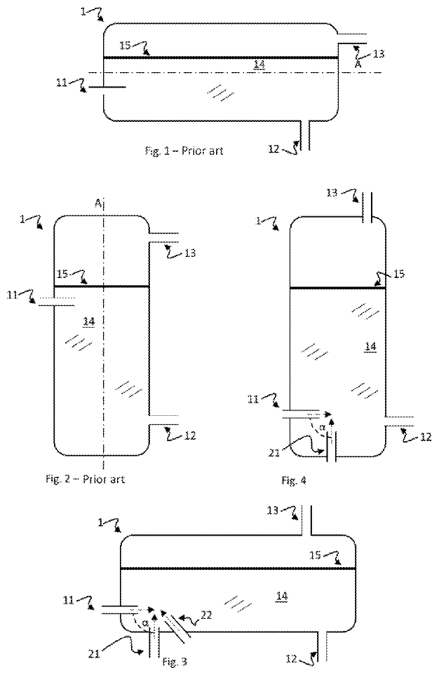

FIGS. 1 to 4 depict various degassing devices 1. All contain a degassing chamber 14. For example, gas-water or gas-lye. The gas may be dihydrogen or dioxygen. The degassing chamber 14 is supplied by a supply pipe 11 for the gas-liquid mixture coming from the electrolyzer stack. In some cases (not shown in the figures), the degassing chamber 14 may also be supplied with gas-liquid mixture coming from the liquid discharge pipe 12 of the degassing chamber 14 by means of a loop controlled by a valve, if a sensor has detected that the quantity of gas present in the discharge from the degassing chamber 14 is greater than a predetermined value. The degassing chamber 14 also comprises a pipe for discharge of gas, gas having been separated from the liquid phase, which can then either be discharged from the plant or reunited with the same gas from the electrolyzer stack. It will be noted that the gas discharge pipe 13 is always arranged above the gas-liquid interface 15. It may be located, for example, in the upper wall or in the or a side wall of the degassing chamber 14. Similarly, the liquid discharge pipe 12 is always arranged below the gas-liquid interface 15. It may be located, for example, in the lower wall (bottom wall) or in the or a side wall of the degassing chamber 14. The precise location of the discharge pipe 12 or 13 is not critical. As can be seen, however, in all the cases shown, the discharge pipe 12 or 13 has been arranged on the opposite side to, that is to say at the furthest distance from the supply pipe 11 of the degassing chamber 14, in order to allow a longer path for the liquid in the degassing device 1. As can also be seen, the degassing device may be arranged along a horizontal (FIGS. 1 and 3) or vertical (FIGS. 2 and 4) axis A, depending on structural requirements, for example.

The degassing devices according to the invention depicted in FIGS. 3 and 4 show an additional supply pipe 21 through which the degassing chamber 14 is supplied with gas-liquid mixture. The degassing chamber 14 is therefore supplied with gas-liquid mixture by the two supply pipes 11 and 21. FIG. 4 also shows another additional supply pipe 22 through which the degassing chamber 14 is supplied with gas-liquid mixture. The degassing chamber 14 is therefore supplied with gas-liquid mixture by the three supply pipes 11, 21 and 22. The supply pipes 11 and 21 intersect at least partially within the gas-lye mixture in the degassing chamber 14. The trajectories of the jets emerging from these pipes therefore intersect partially or, preferably, fully. An additional supply pipe 22 can be seen in FIG. 4. In this figure, the three jets intersect in the same area of the degassing device; this embodiment is advantageous but is not essential. Moreover, the configurations could be reversed or even further gas-liquid mixture supply pipes could be added to the degassing chamber 14. In the embodiment of the invention illustrated, the supply pipes are positioned in the same vertical plane. In another embodiment of the invention, the supply pipes are positioned in the same horizontal plane.

As explained above, a pump may be provided to accelerate the jet injected into the degassing chamber 14 via the pipe 11, or via the pipe 21 or 22 or via several pipes.

As can be seen in FIG. 3, the jets of gas-liquid mixture introduced via the pipes 11 and 21 are arranged in such a way as to intersect at an angle α of 90°. The jets of gas-liquid mixture introduced via the pipes 11 and 22 are arranged in such a way as to intersect at an angle α of 90°. As can be seen in FIG. 3, the degassing chamber 14 contains two additional gas-liquid mixture supply pipes (21 and 22). Said pipes (21 and 22) are arranged in such a way that the jets coming from the pipes 11 and 21 intersect at an angle of approximately 90°, the jets coming from the pipes 11 and 22 intersect at an angle of approximately 135° and the jets coming from the pipes 21 and 22 intersect at an angle of approximately 45°. It would also be possible to provide for the three jets to intersect at an angle of 90°. In FIG. 4 only one additional pipe 21 is shown; it will be appreciated that other pipes may also be added. In other embodiments of the invention, other configurations characterized by other angular values are also to be taken into consideration.

List of drawing references:

| | |
|---|---|
| 1 | Degassing device |
| 11 | Gas-liquid mixture supply pipe |
| 12 | Liquid discharge pipe |
| 13 | Gas discharge pipe |
| 14 | Gas-liquid separation chamber |
| 15 | Gas-liquid interface |
| 21 | Additional supply pipes |
| 22 | Additional supply pipes |
| A | Main axis of the gas-liquid separator |

1. A degassing device (1) for an electrolysis plant comprising a degassing chamber (14) having
an opening for a first gas-liquid mixture supply pipe (11);
an opening for a liquid discharge pipe (12) arranged below the level of the gas-liquid interface (15) of the degassing chamber (14);
an opening for a gas discharge pipe (13) arranged above the level of the gas-liquid interface (15) of the degassing chamber (14);
characterized in that the degassing chamber (14) comprises
one or more additional opening(s) for one or more additional gas-liquid mixture supply pipe(s) (21, 22), said one or more additional gas-liquid mixture supply pipe(s) (21, 22) being arranged such that the jets of gas-liquid mixture introduced into the degassing chamber (14) through the supply pipes (11, 21, 22) intersect within the gas-lye mixture in the degassing chamber (14).

2. The degassing device (1) as claimed in claim 1, wherein the degassing chamber (14) comprises an additional opening for an additional gas-liquid mixture supply pipe (21).

3. The degassing device (1) as claimed in claim 2, further comprising a pump configured to accelerate at least one of the jets injected into the degassing chamber (14).

4. The degassing device (1) as claimed in claim 2, further comprising a reduction in section of the supply pipe configured to accelerate at least one of the jets injected into the degassing chamber (14).

5. The degassing device (1) as claimed in claim 1, wherein at least two jets intersect at an angle (α) of between 15° and 180°.

6. The degassing device (1) as claimed in claim 5, wherein at least two jets intersect at an angle (α) of between 90° and 180°.

7. An electrolysis plant comprising a degassing device as claimed in claim 1.

8. The electrolysis plant as claimed in claim 7, wherein the electrolysis cell operates on the principle of alkaline electrolysis.

9. A degassing method for degassing a gas-liquid mixture in an electrolysis plant as claimed in claim 7, wherein
a part of the gas-liquid mixture is introduced through the first supply pipe (11) into the degassing device,
one or more other part(s) of the gas-liquid mixture is (are) introduced through one or more additional supply pipe(s) (21, 22) into the degassing chamber (14),
wherein the jets of gas-liquid mixture introduced into the degassing chamber (14) through the supply pipes (11, 21, 22) intersect within the gas-lye mixture in the degassing chamber (14).

10. The degassing method as claimed in claim 9, wherein at least one of the jets injected into the degassing chamber (14) is accelerated, propelled or ejected into the degassing chamber (14).
